(19) United States
(12) Patent Application Publication
(10) Pub. No.: US 2010/0306792 A1
(43) Pub. Date: Dec. 2, 2010

(54) METHODS AND SYSTEMS FOR CORRELATED INFORMATION SERVICES

(75) Inventors: Xiaodong Li, Kirkland, WA (US); Titus Lo, Bellevue, WA (US)

Correspondence Address: PERKINS COIE LLP;PATENT-SEA, P.O. BOX 1247, SEATTLE, WA, 98111-1247, US

(73) Assignee: NEOCIFIC, INC., BELLEVUE, WA (US)

(21) Appl. No.: 12/513,660

(22) PCT Filed: Nov. 8, 2007
(86) PCT No.: PCT/US07/84174

§ 371 Date: Feb. 16, 2010

Related U.S. Application Data
(60) Provisional application No. 60/857,567, filed on Nov. 8, 2006.

(51) Int. Cl. H04N 7/16; H04N 7/173; H04N 7/025

(52) U.S. Cl. 725/23; 725/131; 725/114; 725/34

(57) ABSTRACT

Methods and systems are disclosed for providing correlated information services with broadcast multimedia content. In conjunction with a broadcast system offering a plurality of primary channels that carry entertainment, informational, and educational multimedia programs, the disclosed systems may provide one or more auxiliary channels containing complementary, correlated, or/and personalized information. Broadcast services are typically carried in a mass distribution system, such as a co-axial cable distribution network, a telephone distribution network, a satellite system, a radio system, a TV broadcast system, or a cellular broadcast system. The one or more auxiliary channels for delivery of the complementary, correlated, and/or personalized information service can be established in the same or different data distribution system, such as a cable modem system, a DSL system, a WiFi network, a WiMAX network, or a wireless data network.

### CROSS-REFERENCE TO RELATED APPLICATION(S)

This application claims the priority of U.S. Provisional Application No. 60/857,567 entitled METHODS AND SYSTEMS FOR CORRELATED INFORMATION SERVICES, filed Nov. 8, 2006, which is hereby incorporated by reference in its entirety.

### TECHNICAL FIELD

The disclosed methods and systems relate, in general, to TV broadcast services, broadband data services, and information services, and, in particular, to methods and systems for correlated information services.

### BACKGROUND

Cable and satellite TV is a relatively old medium and people have been relying on it for information and entertainment for decades. To most households, cable and satellite TV is so common that it has become a part of their daily life. The service model for TV has changed very little, where TV programs are paid by TV advertisements, which are often not immediately relevant to the viewers.

Broadband data is a relatively new medium, but it has been catching on rapidly and become more and more common among households. Many heavily rely on broadband data services in their daily living. Some simply cannot do without it. Yet, broadband data services cannot deliver the types of entertainment that cable TV does.

Another relatively new medium is wireless, enabled and empowered by the sophisticated portable (mobile) devices such as smart phones and PDA. These devices are multi-functional and interactive, and can store a significant amount of data.

The services provided over the old and new media are usually not integrated in a sense that they are complementary and correlated to each other. Consumers would benefit if the services offered through the old and new media were more tightly integrated to provide a range of new offerings to consumers.

### BRIEF DESCRIPTION OF THE DRAWINGS

FIG. 1 depicts the concept of using primary channels for broadcasting and auxiliary channels for correlated information services.

FIG. 2 illustrates a pushing-storing-pulling process in providing a correlated information service.

FIG. 3 depicts a representative environment for the distribution of correlated information services with TV broadcast services through a wire-based distribution network.

FIG. 4 depicts a representative environment for the distribution of correlated information services with TV broadcast services through a wireless distribution network.

FIG. 5 depicts the insertion of correlated information at a network node, where it is multiplexed and delivered along with TV segments.

FIG. 6 depicts a mechanism for downloading correlated information to the user device.

FIG. 7 depicts a mechanism for replacing general advertisements with personalized advertisements.

FIGS. 8A and 8B depict a mechanism of associating and delivering a TV program with its relevant correlated information.

FIG. 9 illustrates the major components of a correlated information service system.

FIG. 10 is a block diagram of a typical set-top box.

FIG. 11 illustrates a typical setup for a user to control a set-top box and a user device using a remote control with the assistance of a text or graphic menu shown on a display.

### DETAILED DESCRIPTION

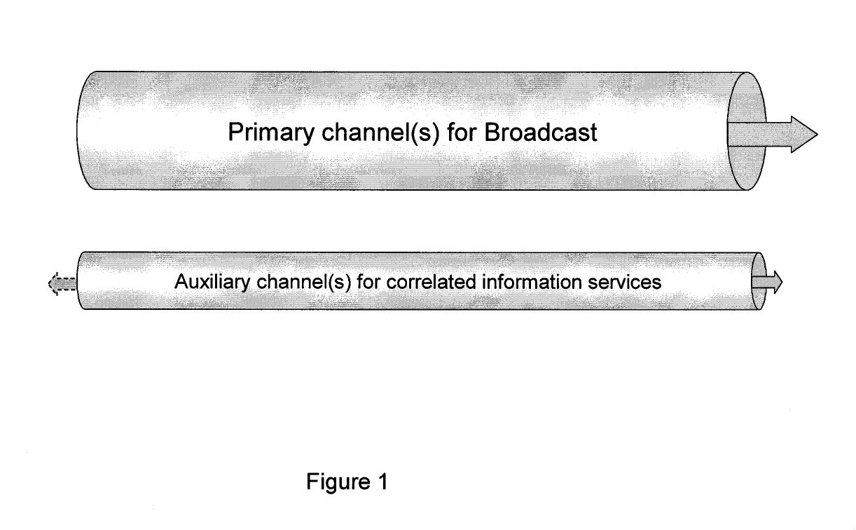

Methods and systems are disclosed for providing correlated information services with broadcast multimedia content. In conjunction with a broadcast system offering a plurality of primary channels that carry entertainment, informational, and educational multimedia (including video and audio) programs, the disclosed systems may provide one or more auxiliary channels containing correlated, complementary, and/or personalized information (hereinafter collectively referred to as “correlated information”) that relates to the content on the primary channels. Broadcast services are typically carried in a mass distribution system, such as a co-axial cable distribution network, a telephone distribution network, a satellite system, a radio system, a TV broadcast system, or a cellular broadcast system. The one or more auxiliary channels for delivery of the correlated information service can be established in the same or different data distribution system, such as a cable modem system, a DSL system, a WiFi network, a WiMAX network, or a wireless data network. FIG. 1 is a conceptual diagram showing the parallel channels for delivery of broadcast services and correlated information. It will be appreciated that the addition of correlated information services related to broadcast services significantly increases the commercial value of the broadcast services.

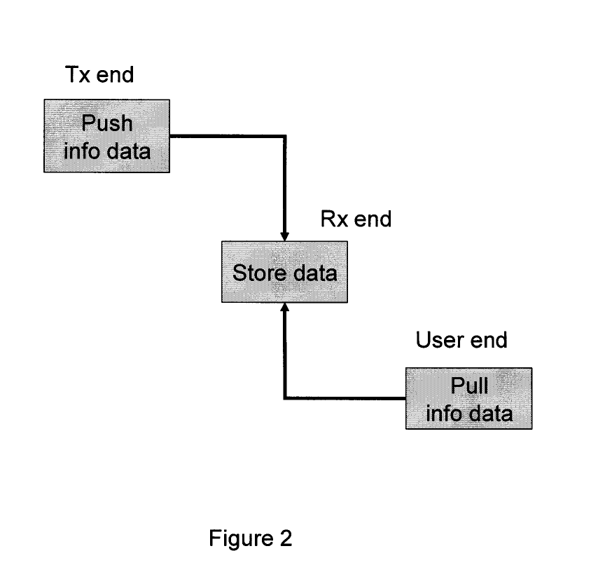

In some embodiments, the correlated information service may be delivered in the pushing-storing-pulling process depicted in FIG. 2. The correlated information is pushed from the transmitter end (e.g., data distribution center) to the receiver end (e.g., a set-top box (STB) or other user device) and stored in the memory of the receiver. In some cases, the STB is the transmitter and pushes the correlated information to the user device, which stores the correlated information in its memory. When needed, a particular piece of correlated information is pulled from the memory to be processed and presented to the user.

The correlated information provided by the disclosed systems may take a variety of forms. For example, correlated information may be associated with TV advertisements to create value-added services; correlated information may allow TV advertisements to be tailored to groups, households or individuals for maximum effects; and correlated information associated with TV programs may allow viewers to inquire and acquire information relevant to the viewed programs. It is to noted that throughout this text, TV broadcast is intended to be broadly interpreted as any form of TV broadcast, including, without limitation, cable TV, satellite TV, and mobile TV.

In some embodiments, a correlated information service system is installed at a place where goods and services are sold or provided, where it interacts with a user device containing previously-stored correlated information. As will be described in further detail herein, the system and user device exchange information in such a way as to improve the user's shopping experience.

In some embodiments, systems and devices are designed with special capability to enable the correlated information services. These systems and devices include the broadcast system that provides and broadcasts the TV programs and correlated information, the correlated information service system installed at a place where goods and services are sold or provided, the set-top box (STB) that receives TV programs and correlated information and re-transmits correlated information at the subscriber's premise, the user device that communicates with the set-top box, and the correlated information service system and that is designed to enhance the user experience.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

### I. Value-Added TV Broadcast Services

Various methods are now described that may he used to supplement TV broadcast services with correlated information, thereby enhancing the user viewing experience by combining the old and new media while more fully exploiting the capabilities of set-top boxes and portable user devices. In particular, TV advertisements are complemented by correlated information to create value-added services; correlated information may allow TV advertisements to be tailored to groups, households or individuals for maximum effects; and correlated information associated with TV programs may allow viewers to instantly receive information relevant to the viewed programs.

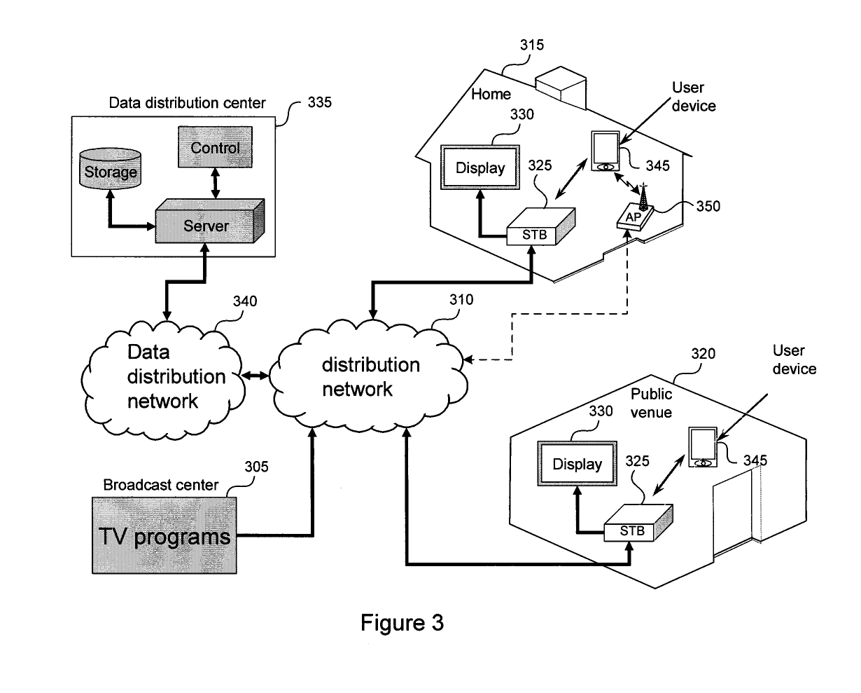

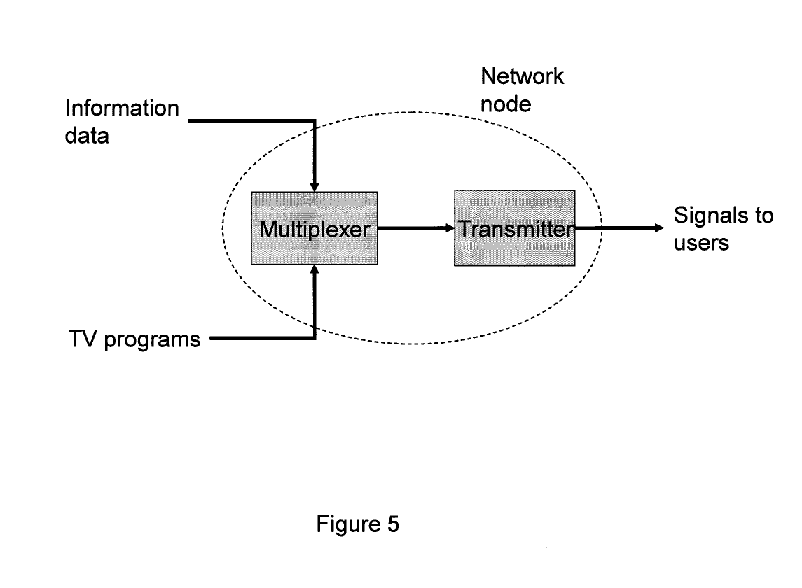

A block diagram is shown in FIG. 3 that depicts a representative environment for the distribution of correlated information services. Broadcast content is transmitted from a broadcast center 305 and delivered over a distribution network 310 to private premises 315 (e.g., home, gas station, waiting area in an office), public venue 320 (e.g., airport, bus depot, hospital), or other location. The distribution network 310 may be a cable network, satellite network, network of UHF or VHF antennas, or other distribution technology. A set-top box 325 or other receiver at the receiving facility receives the transmitted broadcast content and delivers it to a display 330. Correlated information associated with the broadcast content is transmitted from a data distribution center 335. Data distribution center may be collocated with the broadcast center, or may be a separate facility. The data distribution center transmits correlated information via a data distribution network 340. The correlated information may be combined with the broadcast content and delivered via the distribution network 310. That is, the correlated information may be inserted at a network node, multiplexed, and delivered along with the TV segments (including programs and advertisements) by a service provider or network operator, such as depicted in FIG. 5. Alternatively, the correlated information may be delivered via a different distribution network to the set-top box 325 where it is associated with the broadcast content. It will be appreciated that the owner and operator of the broadcast distribution network may or may not be the same business entity as the owner and operator of the correlated information distribution network.

Once delivered to the set-top box, the correlated information may be provided to one or more mobile user devices 345 via a wired or wireless connection. For example, the set-top box may act as a wireless access point to transmit the correlated information to the mobile user device 345. User devices may include a personal digital assistant (PDA), portable email device, tablet PC, laptop, mobile phone, remote control, or other mobile computing device that is enabled to wirelessly receive data.

In some embodiments, rather than being delivered to the set-top box, the correlated information may be independently delivered to a computer (not shown) coupled to a wireless access point 350 at the receiving location. The correlated information is synched to the broadcast content based on the time of day and information reported from the set-top box to the broadcast center or data distribution center that indicates the broadcast content currently being viewed by the user. The wireless access point may retransmit the correlated information to one or more mobile user devices.

The correlated information may be personalized for the user of the device. The user device may contain a profile that is associated with the user of the device that contains the likes and dislikes of a user. The profile may be manually specified by the user, such as when a user specifies their age, sex, and interests. The profile may also be automatically constructed by observing the user's purchase or browsing behavior over time. For example, the user device may contain a browser or other interface program that allows the user to access and make purchases from network-accessible sites. The user device may monitor the purchases made by the user and maintain a list of products that are of interest by the user. As another example, the user device may monitor the browsing behavior of the user when visiting network sites. If the user frequents sites having certain content (e.g., Subaru automobiles), the user device may assume that the user is interested in that content and may update the user's profile accordingly. The profile may also be based on media or other content that the user has stored on the user device. For example, if the user enjoys jazz music and has a number of Charlie Parker jazz tracks stored on the user device, the user's profile may be updated to indicate that the user is interested in jazz music in general and Charlie Parker specifically. As will be described in additional detail below, by comparing the profile of the user with the available correlated information the system may closely tailor the correlated information to the user of the device.

Correlated information is transmitted from the data distribution center to the user device. Certain correlated information may be selected for display to a user (i.e., the delivered data is personalized for the user) by the user device after the user device has received all correlated information associated with a particular broadcast. Alternatively, the set-top box 325 or access point 350 may maintain a copy of the user profile and only transmit certain correlated information to the user device that is associated with the broadcast contents and is selected as being of interest to the user.

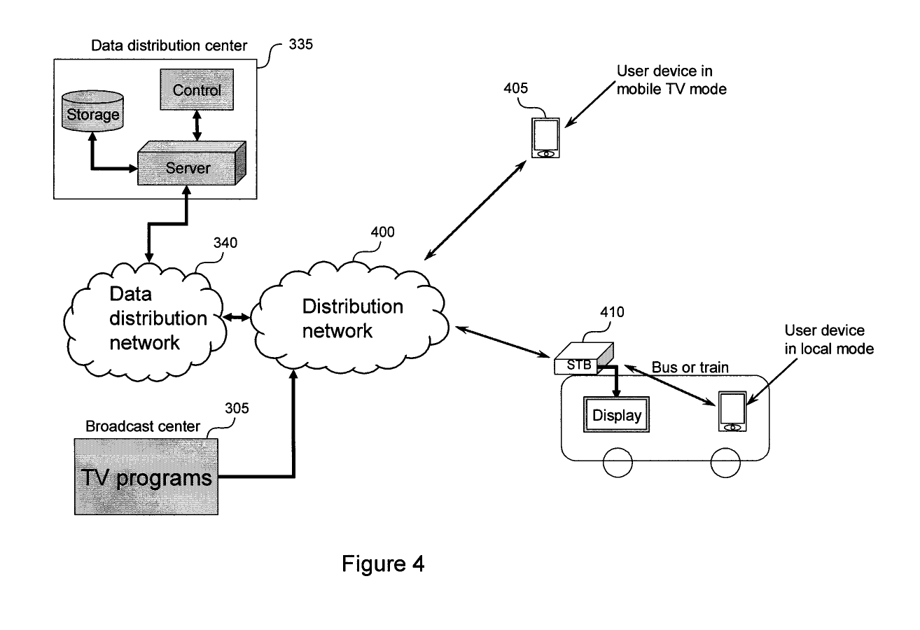

Correlated information services can also be provided through a wireless distribution network 400, as illustrated in FIG. 4, where services are wirelessly delivered to a user device 405 or to a set-top box 410 or other receiver located in a vehicle, such as a bus, train, a boat, or plane. The same wireless distribution network 400 may be used to deliver the correlated information as the broadcast content, or different wireless distribution networks may be used to deliver the correlated information and the broadcast content. In the former case, the correlated data may be multiplexed with the broadcast data as depicted in FIG. 5. In the latter case, the correlated information is associated with the appropriate broadcast content when both are received at the user device 405 or the set-top box 410.

It will be appreciated that the distribution network 400, as well as the wireless link between the user device 405 and the set-top box 410, access point 350, or other receiver, may be a bi-directional communication link. For example, set-top box 410 may transmit messages, reporting information, viewing information, and other data to the broadcast center 305 and to the data distribution center 335. Similarly, the user device 405 may transmit messages, profile information, and other data to the set-top box 410. For example, when a user enters a room and begins to watch broadcast TV, a login procedure may automatically or manually occur between the user device and the set-top box. During the login procedure, the user device may transmit user profile information to the set-top box to enable the set-top box to personalize correlated information that is transmitted from the set-top box to the user device. Data received from the user device at the set-top box may be processed at the set-top box or re-transmitted to the broadcast center or data distribution center.

A. Supplementary TV Advertisement Services

In accordance with some embodiments, TV advertisements are complemented by delivering additional correlated information to provide value-added services to users. As previously described, a set-top box 325 or receiver at the subscriber premises receives both the signals of the TV advertisement and relevant correlated information. The TV signal is directed to a display device 330, such as a TV set, and the correlated information is transmitted from the set-top box via a wireless network (e.g., a wireless LAN) or other transmission medium to a user device 345. Alternatively, the correlated information may be transmitted to the user device via access point 350.

The correlated information can be any information that would supplement the broadcast content and provide value to the user. For example, the correlated information may be local information to supplement a national or regional TV advertisement. Such local information may include, but not be limited to:
where to buy the advertised goods or services, such as store locations, maps, and driving directions;
when to buy the advertised goods or services, such as sale periods or showing schedules;
discount or on-sale information on the advertised goods or services;
the availability of the advertised goods and services, such as choices of size, color, styles, and options; and
samples of the advertised goods or services, such as pictures of goods, music segments, and movie trailers.

As another example, correlated information may also be broadcast along with a particular TV advertisement to provide information on other goods and services that are:
alternative to the goods or services being promoted in the said advertisement (e.g., tea alternative to coffee);
associated with the goods or services being promoted in the said advertisement (e.g., bread with jam); or
made, sold, or provided by a competitor to the beneficiary of the said advertisement (e.g., Brand A vs. Brand B).

The correlated information associated with a particular advertisement may comprise additional text, images (still or moving), links to website, or electronic coupons (e-coupons) for the goods or services being promoted in the advertisement. The e-coupons can be redeemed in participating local or online stores by presenting the mobile device containing the e-coupon with associated coupon code or transmitting the e-coupon to a retailer as described in additional detail below.

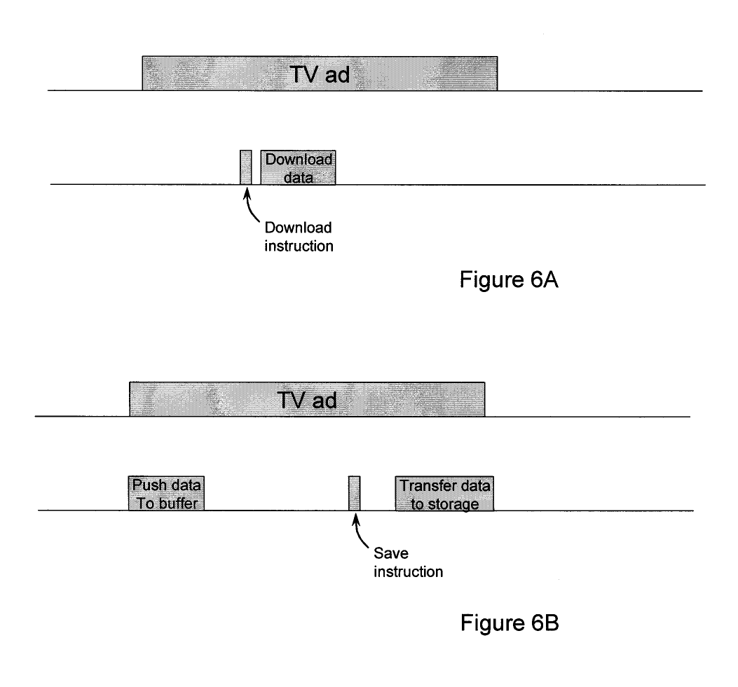

In some embodiments, downloading of the correlated information is initiated by a user sending a control signal as a download instruction (see, e.g., FIG. 6A). In response, the system delivers any correlated information associated with the television advertisement or program that is currently being broadcast. Alternatively, correlated information may be continuously pushed to a buffer of the user device during an advertisement or program. Correlated information received by the user device is constantly being deleted or overwritten after a certain period of time, unless the user chooses to save the correlated information by inputting a save instruction (see, e.g., FIG. 6B). When a save instruction is received by the user device, the corresponding correlated information is saved to storage for subsequent review by the user. In some embodiments, the correlated information may be automatically saved by the user device when certain save criteria are met. For example, if the correlated information is related to an item that is contained in a wish-list or shopping list in the user device, the related correlated information may be automatically saved in the user device storage.

The correlated information associated with a particular advertisement may comprise information that facilitates or enables the user to start or complete the purchase of the goods or services being promoted in the the corresponding advertisement. In some embodiments, purchasing information for the advertised goods and services may be included in the correlated information and transmitted to the user device. When the user wishes to purchase the goods and services being promoted in the advertisement, by pressing one or more keys the user is led to a designated website to complete the transaction. Alternatively, the user can purchase the goods or services being promoted in the advertisement by pressing one or more keys on the user device or the TV remote control using a preset account. For example, a “buy key” may be present on the user device that, when depressed, causes the user device to send the necessary data through a secured channel to complete a purchase transaction using previously-stored account information.

The correlated information that is presented to a user may be personalized to the interests of the user based on a user profile. For example, a first user watching a TV advertisement on Las Vegas may receive special hotel offers if the user enjoys traveling, while a second user watching the same TV advertisement on Las Vegas may receive a notification of an upcoming concert if the user has previously shown an interest in the concert's performer. As another example, a husband watching a TV advertisement for jewelry may be presented with correlated information reminding him of an upcoming anniversary. At the same time, his wife watching the same TV advertisement may receive correlated information depicting a bracelet that complements a necklace that she had previously purchased. The selection of correlated content to display may occur using collaborative filtering or other recommendation technologies such as disclosed in B. M. Sarwarm et al., “Analysis of Recommendation Algorithms for E-Commerce,” ACM Conf. Electronic Commerce, ACM Press, 2000, pp. 158-167, or Miquel Montaner, Beatriz López, Josep Lluis De La Rosa, A Taxonomy of Recommender Agents on the Internet, Artificial Intelligence Review, v. 19 n. 4, p. 285-330, June 2003, which are hereby incorporated in their entirety by this reference. Personalizing the correlated information to a receiving user increases the value of the information to the user. For users without a user profile, the system may deliver default correlated information that the system determines to have the broadest potential appeal.

B. Personalized TV Advertisements

In accordance with some embodiments, personalized TV advertisements may be unicast or multicast via one or more auxiliary channels by a service provider or network operator to a specific subscriber or a specific group of subscribers. The personalized TV advertisements are created to target different market segments or different demographic viewer groups, households or individuals by tailoring to subscribers' living styles, cultures, traditions, TV watching patterns, buying patterns, coupon downloading pattern, and other related statistics.

Personalized TV advertisements are transmitted to and stored in the set-top box at a target household. During a regular advertisement period, the set-top box replaces one or more general TV advertisements with the stored personalized ones. The set-top box may select the personalized advertisements for replacement in a random fashion, in a prescribed order, or based on the TV program being watched. The general TV advertisements can also be replaced by personalized advertisements in real time through a unicast channel. In some embodiments, the personalized advertisements stored in the set-top box are updated periodically by the service provider. The update rate may depend on the viewing pattern or other statistics in that household.

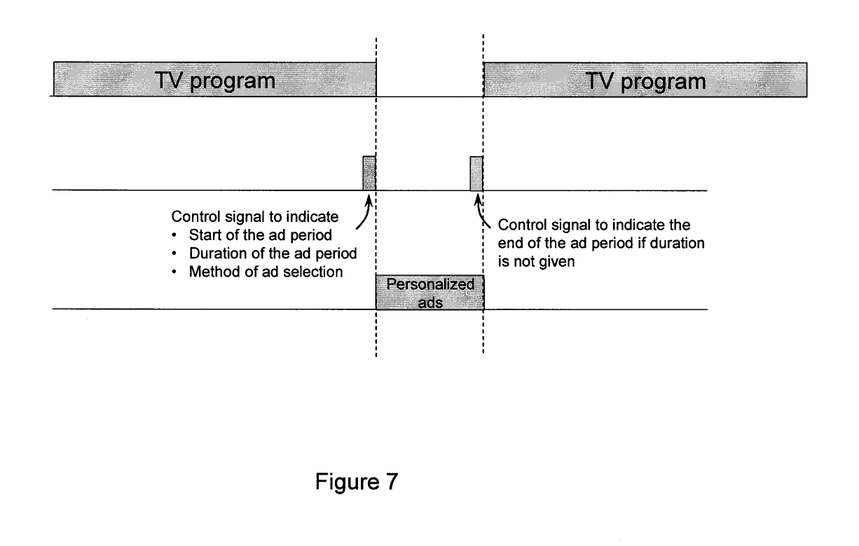

In some embodiments, control signals are transmitted from the broadcast center to the set-top box to enable and instruct the set-top box when to replace the general advertisements with the personalized ones (FIG. 7). For example, the control signal may specify the start and length of an advertising period in which personalized advertisements may be inserted for a user. Based on a selection of stored or available personalized advertisements and the length of the advertising period, the set-top box may select one or more personalized advertisements to deliver to the user during the advertising period. The content of the personalized advertisements may be targeted to a user based on, for example, information contained in the user's profile. Any time that isn't allocated for personalized advertisements may be used for general advertisements instead.

In the case where there are multiple TV sets in a household, personalized TV advertisements may be selected to match the taste of the individual user of each TV set.

The method and mechanism for replacing general advertisements with personalized advertisements can be extended to a general case where one TV segment that is broadcasted via a primary channel is replaced by another segment that is delivered via an auxiliary channel.

C. Complementary Information to TV Programs

In accordance with some embodiments, TV programs are accompanied by correlated information to allow viewers to, substantially instantly or otherwise, receive additional information relevant to the programs being viewed.

The TV program is logically divided in to a plurality of sections based on a certain criteria, such as time or scene, and each section is indexed. The indexing can be an absolute value or can be a value relative to a reference. The lengths of the sections are not necessarily equal. The correlated information associated with the TV program is also divided into blocks in such a way that each block corresponds to the relevant section of the TV program. Each block is also labeled with an index essentially the same as the index for the section of the TV program.

A set-top box at the customer premise receives the signals of both the TV programs and the correlated information. The TV signal is directed to a display device and the correlated information is transmitted via a transmission medium to a user device. The correlated information is temporarily placed in the buffer of the user device and the user has the choice, by a certain means, to save or delete the information.

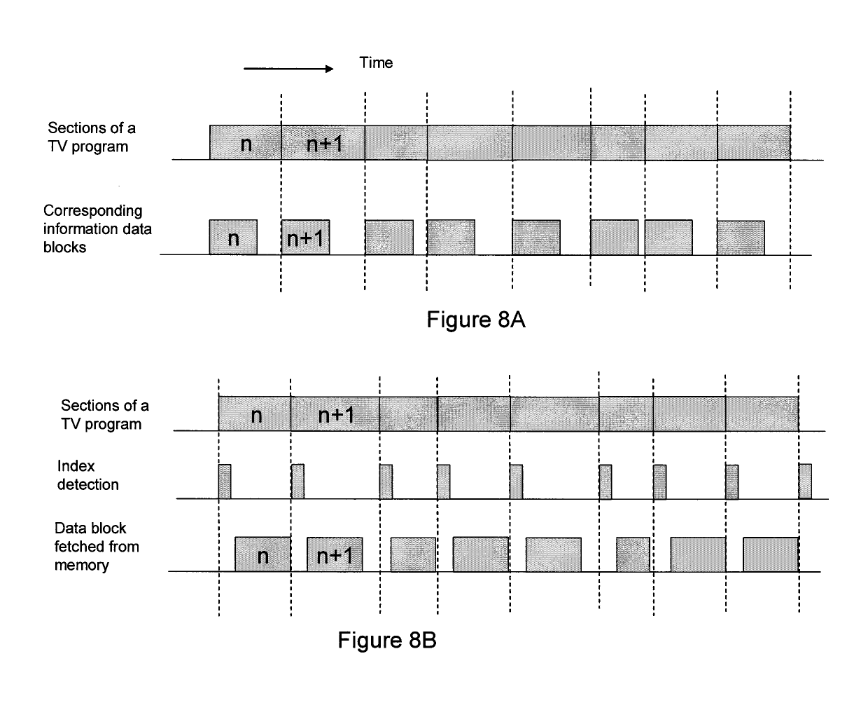

In some embodiments, the sections of the TV program and the corresponding blocks of correlated information are broadcast at essentially the same times, as depicted in FIG. 8A. Alternatively, the correlated information can be broadcast prior to the TV program and stored in the memory of the set-top box. When the TV program is broadcast, the set-top box detects the index of the section being received, retrieves the corresponding correlated information. and transmits the correlated information to the user device or uses the correlated information for other functions, as shown in FIG. 8B. If the length of each section is the same, index detection may only be required once for multiple of sections.

The correlated information associated with a TV program may include:
Product information on the attire and accessories that an actor/actress or individual is wearing in the TV program;
Goods and service information on the hair style, facial, makeup, fitness program, etc. that are used by an actor/actress or individual in the TV program;
Goods and service information on the furniture and interior design for the TV program setting;
Information on any attraction that appears in the TV program; and
Information related to an actor/actress or individual in the TV program or related to the TV program

The relevant correlated information may be presented on the user device in a text or graphic menu. Hyperlinks may be provided for websites that provide additional related information. By interacting with the menu, the user is led to one of the designated websites to explore further.

In some cases, the user has the option to input certain information relevant to the program. The user may choose to go to the corresponding website to input the information. Alternatively, the user can input the information by pressing one or more keys on the user device. For example, in the event that the user is asked to vote for A, B, or C in a particular campaign or game, if the user decides to vote, he can just press a “vote key” on the user device and then choose A, B, or C. The user device sends the necessary data through a secured channel to complete the voting. In some circumstances, the user may require the user to previously establish an account with the system in order to verify the user's identity.

In other cases, the correlated information associated with the TV program are transmitted to the user device during the broadcast of the program and stored in the user device's memory. The user can then review the information at a later time.

### II. In-Store Information Services

Some or all of the correlated information acquired with a TV broadcast may be stored in a user device. Such correlated information can be used for the user's benefit when the user takes the user device to a store, a shop, a supermarket, or any place where goods and services are sold or provided and where an information service system is installed to interact with the user device.

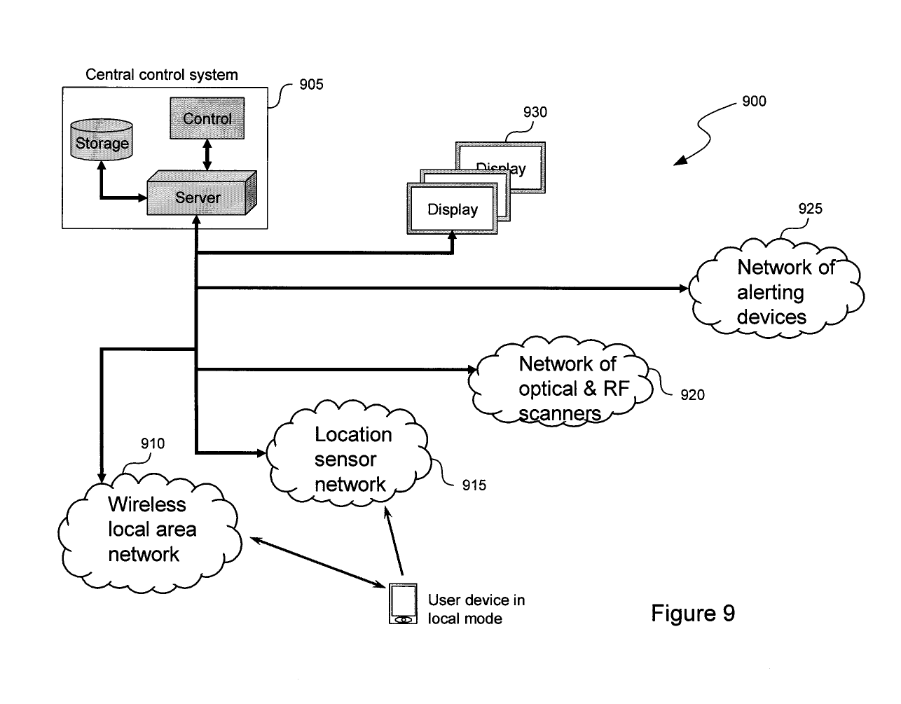

FIG. 9 is a block diagram of an information service system 900 that is located where goods and services are sold or provided (e.g., a store, retailer shop, supermarket). The information service system interacts with a user device to facilitate the promotion and sale of goods and services. The information service system comprises one or more of a central control system 905, wireless local area network with access points 910, a location sensor network 915, a network of optical or/and RF scanners 920, a network of alerting devices 925, and electronic displays 930. These components are positioned at desired locations throughout the installed premises.

The user may access the information service system via the access points 910, and cause the user device to transmit some or all of the correlated information to the information service system. For example, the user may transmit e-coupons related to the goods or services sold by the retailer.

To facilitate interaction with a user, the information service system may show items on one of its electronic displays 930. The information service system may also transmit information related to the displayed items (e.g., their availability, locations and prices) to the user device. Furthermore, the system may broadcast additional information (including e-coupons) about additional or alternative goods and service to the user device. The system also transmits the personalized shopping information data to the user device if the user is a repeat shopper.

In some embodiments, when the system senses, via its location sensor network 915, the user in proximity to an item for which the user has stored correlated information, the system alerts the user via its network of alerting devices 925 or sends an instruction signal to the user device to alert the user.

The user device can be used to scan, via optical, RF, or other means, the items to be purchased and compute the total amount necessary to purchase the items (including automatically applying the amount of reduction from the e-coupons). The information on the purchased items is verified by the system when the user checks out. The user selects the option of payment on the user device and the device transmits the payment information to the service system to complete the transaction.

Based on a user's purchase history, the user device creates or maintains one or more shopping lists for future use. The shopping lists may be categorized by necessity (e.g., basic or luxury), types (e.g., grocery or apparels), stores (e.g., Target or Safeway), or others. The shopping list may be used to match e-coupons, discounts, or rewards for frequently brought items.

The information service system 900 may also maintain a record of the purchased items by a particular shopper. The system analyses the record and prepares personalized shopping information data for the shopper when the shopper returns to the store. The personalized shopping information data may comprise e-coupons, suggested items, discount and reward information, etc. When the shopper returns to the store, the information service system transmits the personalized shopping information data to the user device.

### III. Enabling Systems and Apparatus

Systems and devices are described to enable the correlated information services. These systems and devices include the broadcast system that provides and broadcasts the TV programs, the information services system installed at a place where goods and services are sold or provided, the set-top box that receives the TV programs and correlated information and transmits correlated information at the subscriber's premise, the user device that communicates with the set-top box, and the information service system that is designed to enhance the user experience.

A. Broadcast System

In accordance with some embodiments, the correlated information is added at a particular node in the distribution network and broadcast to users (subscribers). The correlated information related to a particular scheduled TV segment (e.g., advertisement or program) may be transmitted at essentially the same time as the segment being transmitted. Alternatively, the correlated information related to a particular scheduled TV segment may be transmitted prior to the segment being transmitted and stored in the subscriber set-top box. When transmitted prior to the associated TV segment, the correlated information is tagged with an index or identification number that is used to associate the correlated information with the TV segment that is transmitted at a later time.

The correlated information can be transmitted via an auxiliary channel on the broadcast distribution network. The auxiliary channel is different than the primary channel used for the TV segment, and may be differentiated in the time, frequency, or code domains.

In some embodiments, control signals, which may be in various format such as those previously described with respect to FIGS. 7, 8A, and 8B, are transmitted from the broadcast center to the set-top box to provide control information such as labeling indices or identification numbers, or the beginning and the end or duration of a commercial period. The set-top box may utilize the control signals to trigger the replacement of general advertising with personalized advertising.

B. Set-Top Box

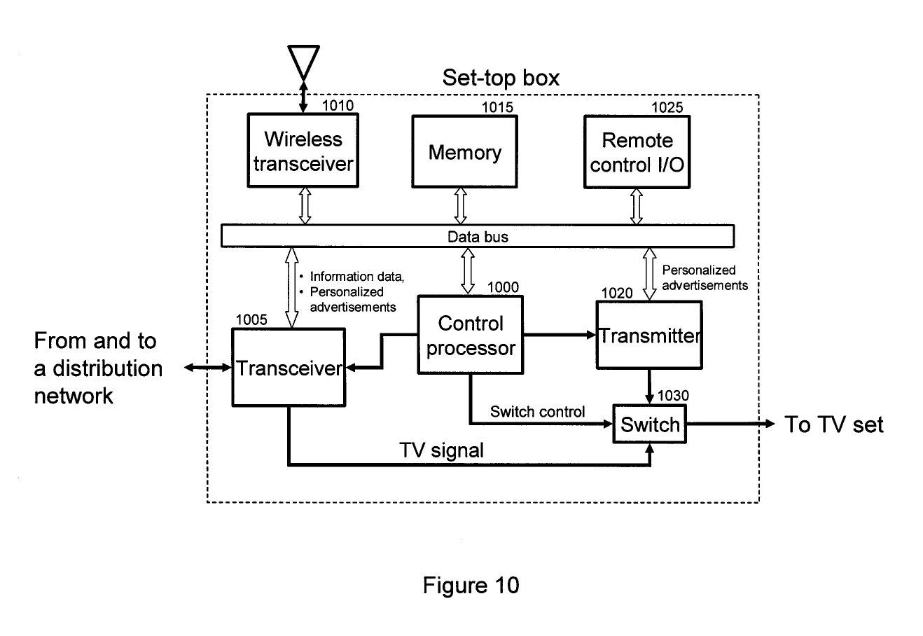

In accordance with some embodiments of this invention, the correlated information and TV broadcast segments are received by a receiver, preferably a set-top box, at the subscriber premises. As depicted in FIG. 10, the set-top box may consist of a control processor 1000, a satellite or cable transceiver 1005, a wireless transceiver 1010, a memory 1015, a cable transmitter 1020, a remote control I/O 1025 and a switch 1030, as depicted in FIG. 10. It is noted that the components in the set-top box are designed to perform certain functions and in some cases, these components may be fully or partially integrated into another device such as a TV set.

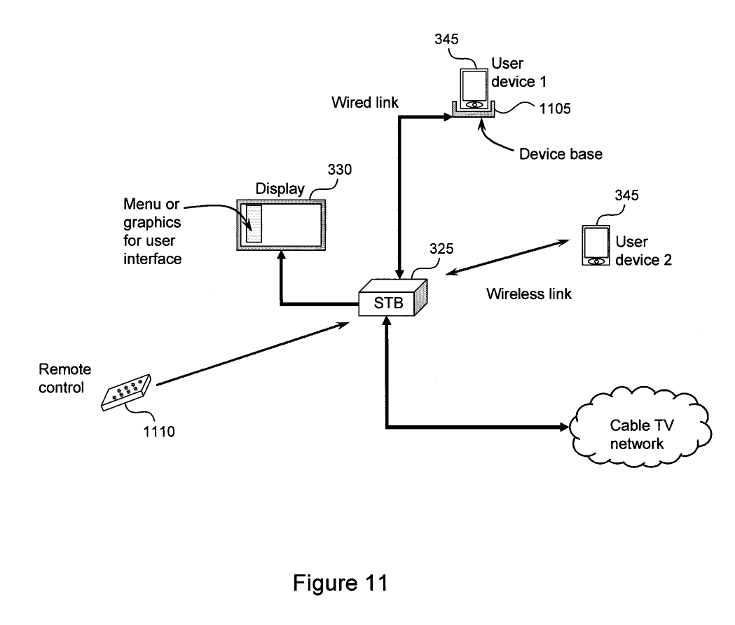

FIG. 11 is a diagram depicting various communication paths with the set-top box. Communication protocols are established to allow the set-top box to communicate with a user device 345 through a wireless link (e.g., IEEE802.11 or IEEE802.15) or through a device base 1105 with a wired link (e.g., Universal Serial Bus or IEEE1394); therefore, a user is able to send instructions to the set-top box. In addition, communication protocols are established to allow a user to control the set-top box and the user device using a remote control 1110. The user may use the remote control to manipulate a text or graphic menu on the display 330 in order to control the set-top box and user device. For example, a user is able to instruct, using the remote control, that certain correlated information be downloaded from the set-top box to the user device. The hot keys (e.g., buy- or vote-key) are also mapped from the user device to the remote control.

Upon receiving the correlated information, the set-top box transmits the correlated information to a user device via wireless or wired means. Alternatively, the set-top box stores the correlated information in its memory and upon receiving a TV segment, the set-top box searches the corresponding correlated information in its storage and transmits the correlated information to a user device via a wireless or wired means. In addition, a user may request the correlated information specifically related to a TV segment; upon receiving the request signal, the set-top box searches the corresponding correlated information in its storage and transmits the information to the user device.

The set-top box also stores personalized advertisements in its memory for subsequent use. Upon receiving control signals and instruction, the set-top box selects one or more personalized advertisements, transmits them via the cable transmitter, and directs the signals through the switch to the display to replace the general advertisements.

C. Information Service System

In accordance with some embodiments, the information service system in a goods and service trading place may comprise one or more of a central control system, a wireless local area network with access points, a location sensor network, a network of optical or/and RF scanners, a network of alerting devices, and electronic displays, as showing in FIG. 9.

The wireless local area network consists of a plurality of optical or RF transceivers, serving as the air-interface between the system and the user device. For example, IEEE802.11 access points can be used. The location sensors, which can be an integrated or separate part of the access points, detect a signal transmitted by the user device that provides sufficient information for the central processor to determine the location of the user device using a particular technique (e.g., triangulation). The optical or/and RF scanners (e.g., bar-code scanners or RFID readers) are used for functions in the check-out process.

In an embodiment, when instructed or triggered, the alerting devices send optical, acoustic, and/or olfactory signals to alert the user.

D. User Device

In accordance with some embodiments, the user device is a multi-functional device, capable of receiving and transmitting data from and to one or more of the set-top box, the access point, the information service system, and the wireless distribution network. The user device may operate in multiple modes. For example, in a cellular mode, it functions as a phone; in a mobile-TV mode, it functions as a mobile TV terminal; and in a local mode, it functions as a station in a wireless local area network.

The device receives, stores, and processes correlated information. For example, the user device is able to sort, categorize, and/or prioritize the correlated information in terms of the user's gender, ethnicity, interest, preference, habit, location, and/or activity. As previously described, such information that describes the likes and dislikes of a user may be stored in a user profile on the user device. The user device may also correlate or compare the correlated information with a specific set of data in its memory and make the required decisions.

The user device may also be capable of reading information on or embedded in goods (e.g., bar codes or RFID tags).

In some embodiments, the user device may comprise two or more banks of memory, one reserved for secure data storage and the other for general purposes. The banks of memory can be separated physically or partitioned logically. The memory reserved for secured data is protected with relatively high level of encryption and access control. The memory allocated for general purposes is protected with relatively low level of encryption and access control to facilitate download of correlated information, including text, audio, and video.

In some embodiments, the user device can be powered by at least two batteries, one reserved for performing basic functions such as phone calls and the other for carrying out general applications such as playing video segments. Alternatively, the user device may reserve a minimum level of power for performing basic functions and any power exceeding that level can be used for carrying out general applications. However, the power reservation can be overridden by the user; that is, the battery (or power) for general purpose can be diverted for basic functions when instructed and vice versa.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes are presented in a given order, alternative embodiments may perform routines having steps in a different order, and some processes may be deleted, moved, added, subdivided, combined, and/or modified to provide alternative or subcombinations. Each of these processes may be implemented in a variety of different ways. Further any specific numbers noted herein are only examples: alternative implementations may employ differing values or ranges.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A set-top box for delivering personalized information to a user in conjunction with the delivery of a television segment to the user, the set-top box comprising:
a receiver for receiving the broadcast of a television segment from a broadcast source;
a receiver for receiving the transmission of correlated data from a distribution source, the correlated data delivering supplemental information that is associated with the received television segment;
a transmitter configured to transmit the received television segment to a television display via a wired connection; and
a transmitter configured to transmit the received correlated data to a mobile device via a wireless connection, wherein a portion of the correlated data is selected for display on the mobile device to a user based on a user profile of the user.

2. The set-top box of claim 1, wherein the television segment and the correlated data are received via the same distribution network.

3. The set-top box of claim 1, wherein the television segment and the correlated data are received via different distribution networks.

4. The set-top box of claim 1, wherein the television segment and the correlated data are received at the same time.

5. The set-top box of claim 1, wherein the correlated data is received and stored prior to the receipt of the television segment.

6. The set-top box of claim 1, wherein the portion of the correlated data that is selected for display to the user is selected prior to transmission of the correlated data to the mobile device.

7. The set-top box of claim 1, wherein the portion of the correlated data that is selected for display to the user is selected after transmission of the correlated data to the mobile device.

8. The set-top box of claim 1, wherein the user profile contains information about the preferences of the user.

9. The set-top box of claim 1, wherein the television segment is a product advertisement and the correlated data contains information about the product contained in the advertisement.

10. The set-top box of claim 9, wherein the information is a coupon.

11. The set-top box of claim 1, wherein the television segment is a television program and the correlated data contains additional information about the contents of the television program.

12. The set-top box of claim 1, wherein the broadcast source and distribution source are operated by the same party.

13. The set-top box of claim 1, further comprising a receiver configured to receive information about the user from the mobile device via the wireless connection.

14. A method of delivering personalized information to a mobile device that is related to a television segment that is delivered to a user, the method comprising:
receiving a television segment from a broadcast source;
receiving correlated data that delivers supplemental information related to the television segment from a distribution source;
transmitting the received television segment to a television display via a wired connection; and
transmitting the received correlated data to a mobile device via a wireless connection, a portion of the correlated data being selected for display on the mobile device to a user based on a user profile of the user.

15. The method of claim 14, wherein the television segment and the correlated data are received at the same time.

16. The method of claim 14, wherein the correlated data is received and stored prior to the receipt of the television segment.

17. The method of claim 14, wherein the television segment and the correlated data are received via the same distribution network.

18. The method of claim 14, wherein the television segment and the correlated data are received via different distribution networks.

19. The method of claim 14, wherein the portion of the correlated data that is selected for display to the user is selected prior to transmitting the correlated data to the mobile device.

20. The method of claim 14, wherein the portion of the correlated data that is selected for display to the user is selected after transmitting the correlated data to the mobile device.

21. The method of claim 14, wherein the user profile contains information about the preferences of the user.

22. The method of claim 14, wherein the television segment is a product advertisement and the correlated data contains information about the product contained in the advertisement.

23. The method of claim 22, wherein the information is a coupon.

24. The method of claim 14, wherein the television segment is a television program and the correlated data contains additional information about the contents of the television program.

25. The method of claim 14, wherein the broadcast source and distribution source are operated by the same party.

26. The method of claim 15, further comprising receiving the user profile transmitted from the mobile device via the wireless connection.

27. A method in a mobile device of delivering personalized information to a user that is related to a television segment concurrently being delivered to the user, the method comprising:
receiving correlated information related to a television segment being displayed to a user;
retrieving a user profile associated with the user that contains information about the preferences of the user;
comparing the preferences of the user contained in the user profile with the received correlated information and identifying a portion of the correlated information that is related to the preferences of the user; and
displaying the identified portion of the correlated information to the user.

28. The method of claim 27, wherein the correlated information is received at the same time that the television segment is being displayed to the user.

29. The method of claim 27, wherein the correlated information is received prior to the television segment being displayed to the user.

30. The method of claim 27, wherein the television segment is a product advertisement and the correlated data contains information about the product contained in the advertisement.

31. The method of claim 30, wherein the information is a coupon.

32. The method of claim 27, wherein the television segment is a television program and the correlated data contains additional information about the contents of the television program.

33. The method of claim 27, wherein the correlated information is received from a set-top box.

34. The method of claim 33, further comprising transmitting information about the user to the set-top box.
